(19) United States
(12) Patent Application Publication
(10) Pub. No.: US 2022/0201000 A1
(43) Pub. Date: Jun. 23, 2022

(54) SECURITY GATEWAY

(71) Applicant: Motional AD LLC, Boston, MA (US)

(72) Inventor: Junsung Kim, Austin, TX (US)

(21) Appl. No.: 17/558,706

(22) Filed: Dec. 22, 2021

Related U.S. Application Data
(60) Provisional application No. 63/129,728, filed on Dec. 23, 2020.

(51) Int. Cl. H04L 9/40; H04L 12/66

(52) U.S. Cl. CPC H04L 63/102; H04L 63/107; H04L 12/66; H04L 63/20; H04L 63/0823; H04L 63/0227

(57) ABSTRACT

Among other things, apparatuses and techniques are described for managing security of devices in a vehicle using a security gateway. In one aspect, a circuit is coupled to a device in a vehicle, and manages communications between the device and entities external to the vehicle. The circuit receives, from an external entity, communication traffic for the device. The circuit determines, using a known security policy for the device, whether the communication traffic is valid communication traffic for the device. The circuit also determines, using a known device profile of the device, whether the communication traffic satisfies characteristics of the device profile. If the communication traffic is valid communication traffic for the device, and the communication traffic satisfies the characteristics of the device profile, the circuit forwards the communication traffic to the device.

### CROSS-REFERENCE TO RELATED APPLICATIONS

This application claims the benefit of priority from U.S. Provisional Patent Application No. 63/129,728, filed on Dec. 23, 2020, the entire contents of which are incorporated herein by reference.

### FIELD OF THE INVENTION

This description relates generally to security gateways, and in particular to a security gateway in a vehicle.

### BACKGROUND

Autonomous or semi-autonomous vehicles include various electronic component devices to facilitate operations of the vehicles, e.g., sensors to gather information about the surrounding environment, processors to process the sensor information to control steering or braking, or both, among others. The various electronic components exchange information among themselves, or with external remote servers or other vehicles, using message exchanges.

### BRIEF DESCRIPTION OF THE DRAWINGS

FIG. 1 shows an example of a vehicle having autonomous capability.

FIG. 2 shows an example “cloud” computing environment.

FIG. 3 shows a computer system.

FIG. 4 shows an example architecture for an autonomous vehicle.

FIG. 5 shows an example of inputs and outputs that may be used by a perception module.

FIG. 6 shows an example of a LiDAR system.

FIG. 7 shows an example of a vehicle having a security gateway.

FIG. 8 shows an example process for managing security in a vehicle using a security gateway.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

In the drawings, specific arrangements or orderings of schematic elements, such as those representing devices, modules, instruction blocks and data elements, are shown for ease of description. However, it should be understood by those skilled in the art that the specific ordering or arrangement of the schematic elements in the drawings is not meant to imply that a particular order or sequence of processing, or separation of processes, is required. Further, the inclusion of a schematic element in a drawing is not meant to imply that such element is required in all embodiments or that the features represented by such element may not be included in or combined with other elements in some embodiments.

Further, in the drawings, where connecting elements, such as solid or dashed lines or arrows, are used to illustrate a connection, relationship, or association between or among two or more other schematic elements, the absence of any such connecting elements is not meant to imply that no connection, relationship, or association can exist. In other words, some connections, relationships, or associations between elements are not shown in the drawings so as not to obscure the disclosure. In addition, for ease of illustration, a single connecting element is used to represent multiple connections, relationships or associations between elements. For example, where a connecting element represents a communication of signals, data, or instructions, it should be understood by those skilled in the art that such element represents one or multiple signal paths (e.g., a bus), as may be needed, to affect the communication.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

Several features are described hereafter that can each be used independently of one another or with any combination of other features. However, any individual feature may not address any of the problems discussed above or might only address one of the problems discussed above. Some of the problems discussed above might not be fully addressed by any of the features described herein. Although headings are provided, information related to a particular heading, but not found in the section having that heading, may also be found elsewhere in this description. Embodiments are described herein according to the following outline:
1. General Overview
2. System Overview
3. Autonomous Vehicle Architecture
4. Autonomous Vehicle Inputs
5. Autonomous Vehicle Security Gateway
6. Example Processes for Managing Vehicle Security using a Security Gateway

### General Overview

In some embodiments, a security gateway is an electronic device that is deployed in a vehicle, such as an autonomous vehicle (AV), to manage communications between other component devices in the vehicle and entities external to the vehicle (for example, remote servers or other vehicles). The security gateway performs security checks to allow only authorized/valid communication traffic between the devices in the vehicle and external entities. The security checks include, among others, enforcing security policies that allow whitelisted traffic (for example, authorized traffic), and detecting evidence of attacks by comparing the traffic to known profiles of the devices.

In some embodiments, the security gateway in a vehicle provides the functionality of a router, a switch, or a firewall, or any combination of these. All communication traffic going in to, or out from, the vehicle is examined by the security gateway, which determines, based on security policies of the vehicle or known profiles of different devices in the vehicle, whether to allow or drop the traffic. In some embodiments, the security gateway includes an intrusion detection engine to detect evidence of security attacks, for example, behavioral abnormalities in operations of one or more devices in the vehicle that are compromised by an external adversary. Additionally or alternatively, the security gateway includes a policy engine to enforce security policies that whitelist authorized communication traffic and/or allowed behaviors at a network level. In this context, a security policy is a set of rules that specifies tasks that a particular device (or a group of devices) is allowed to do. The tasks can include operations that can be performed by device, entities within the vehicle or outside the vehicle that the device can communicate with, or types of messages the device can send or receive, among others. The security policies act as a whitelist, where any task that is specified by a policy is allowed, while any task that is not specified by policy is denied.

The subject matter described herein can provide several technical benefits. For instance, by adding intrusion detection and policy engine to a vehicle gateway, evidence of security attacks can be detected, and security policies that whitelist allowed behaviors can be enforced, at a network level. In doing so, the security risks associated with having a centralized gateway for controlling all communications are mitigated. By having the gateway check all traffic against existing security policies and expected traffic profiles, attacks against component devices in the vehicle, including the security gateway, can be prevented, leading to enhanced security.

### System Overview

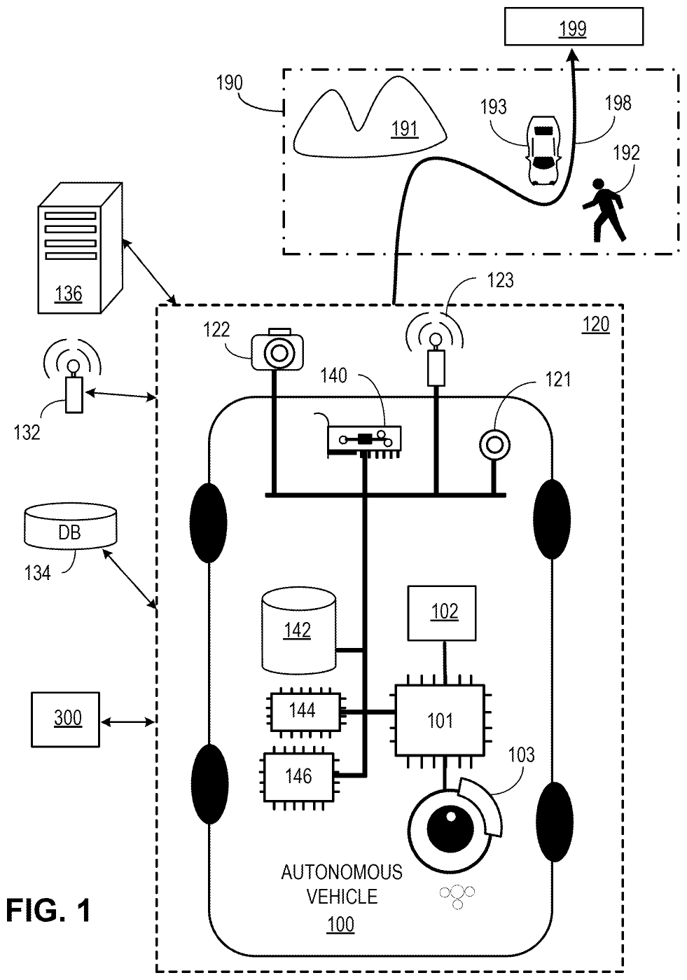

FIG. 1 shows an example of an autonomous vehicle 100 having autonomous capability.

As used herein, the term “autonomous capability” refers to a function, feature, or facility that enables a vehicle to be partially or fully operated without real-time human intervention, including without limitation fully autonomous vehicles, highly autonomous vehicles, and conditionally autonomous vehicles.

As used herein, an autonomous vehicle (AV) is a vehicle that possesses autonomous capability.

As used herein, “vehicle” includes means of transportation of goods or people. For example, cars, buses, trains, airplanes, drones, trucks, boats, ships, submersibles, dirigibles, etc. A driverless car is an example of a vehicle.

As used herein, “trajectory” refers to a path or route to navigate an AV from a first spatiotemporal location to second spatiotemporal location. In some embodiments, the first spatiotemporal location is referred to as the initial or starting location and the second spatiotemporal location is referred to as the destination, final location, goal, goal position, or goal location. In some examples, a trajectory is made up of one or more segments (e.g., sections of road) and each segment is made up of one or more blocks (e.g., portions of a lane or intersection). In some embodiments, the spatiotemporal locations correspond to real world locations. For example, the spatiotemporal locations are pick up or drop-off locations to pick up or drop-off persons or goods.

As used herein, “sensor(s)” includes one or more hardware components that detect information about the environment surrounding the sensor. Some of the hardware components can include sensing components (e.g., image sensors, biometric sensors), transmitting and/or receiving components (e.g., laser or radio frequency wave transmitters and receivers), electronic components such as analog-to-digital converters, a data storage device (such as a RAM and/or a nonvolatile storage), software or firmware components and data processing components such as an ASIC (application-specific integrated circuit), a microprocessor and/or a microcontroller.

As used herein, a “scene description” is a data structure (e.g., list) or data stream that includes one or more classified or labeled objects detected by one or more sensors on the AV vehicle or provided by a source external to the AV.

As used herein, a “road” is a physical area that can be traversed by a vehicle, and may correspond to a named thoroughfare (e.g., city street, interstate freeway, etc.) or may correspond to an unnamed thoroughfare (e.g., a driveway in a house or office building, a section of a parking lot, a section of a vacant lot, a dirt path in a rural area, etc.). Because some vehicles (e.g., 4-wheel-drive pickup trucks, sport utility vehicles, etc.) are capable of traversing a variety of physical areas not specifically adapted for vehicle travel, a “road” may be a physical area not formally defined as a thoroughfare by any municipality or other governmental or administrative body.

As used herein, a “lane” is a portion of a road that can be traversed by a vehicle. A lane is sometimes identified based on lane markings. For example, a lane may correspond to most or all of the space between lane markings, or may correspond to only some (e.g., less than 50%) of the space between lane markings. For example, a road having lane markings spaced far apart might accommodate two or more vehicles between the markings, such that one vehicle can pass the other without traversing the lane markings, and thus could be interpreted as having a lane narrower than the space between the lane markings, or having two lanes between the lane markings. A lane could also be interpreted in the absence of lane markings. For example, a lane may be defined based on physical features of an environment, e.g., rocks and trees along a thoroughfare in a rural area or, e.g., natural obstructions to be avoided in an undeveloped area. A lane could also be interpreted independent of lane markings or physical features. For example, a lane could be interpreted based on an arbitrary path free of obstructions in an area that otherwise lacks features that would be interpreted as lane boundaries. In an example scenario, an AV could interpret a lane through an obstruction-free portion of a field or empty lot. In another example scenario, an AV could interpret a lane through a wide (e.g., wide enough for two or more lanes) road that does not have lane markings. In this scenario, the AV could communicate information about the lane to other AVs so that the other AVs can use the same lane information to coordinate path planning among themselves.

The term “over-the-air (OTA) client” includes any AV, or any electronic device (e.g., computer, controller, IoT device, electronic control unit (ECU)) that is embedded in, coupled to, or in communication with an AV.

The term “over-the-air (OTA) update” means any update, change, deletion or addition to software, firmware, data or configuration settings, or any combination thereof, that is delivered to an OTA client using proprietary and/or standardized wireless communications technology, including but not limited to: cellular mobile communications (e.g., 2G, 3G, 4G, 5G), radio wireless area networks (e.g., Wi-Fi) and/or satellite Internet.

The term “edge node” means one or more edge devices coupled to a network that provide a portal for communication with AVs and can communicate with other edge nodes and a cloud based computing platform, for scheduling and delivering OTA updates to OTA clients.

The term “edge device” means a device that implements an edge node and provides a physical wireless access point (AP) into enterprise or service provider (e.g., VERIZON, AT&T) core networks. Examples of edge devices include but are not limited to: computers, controllers, transmitters, routers, routing switches, integrated access devices (IADs), multiplexers, metropolitan area network (MAN) and wide area network (WAN) access devices.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this description, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

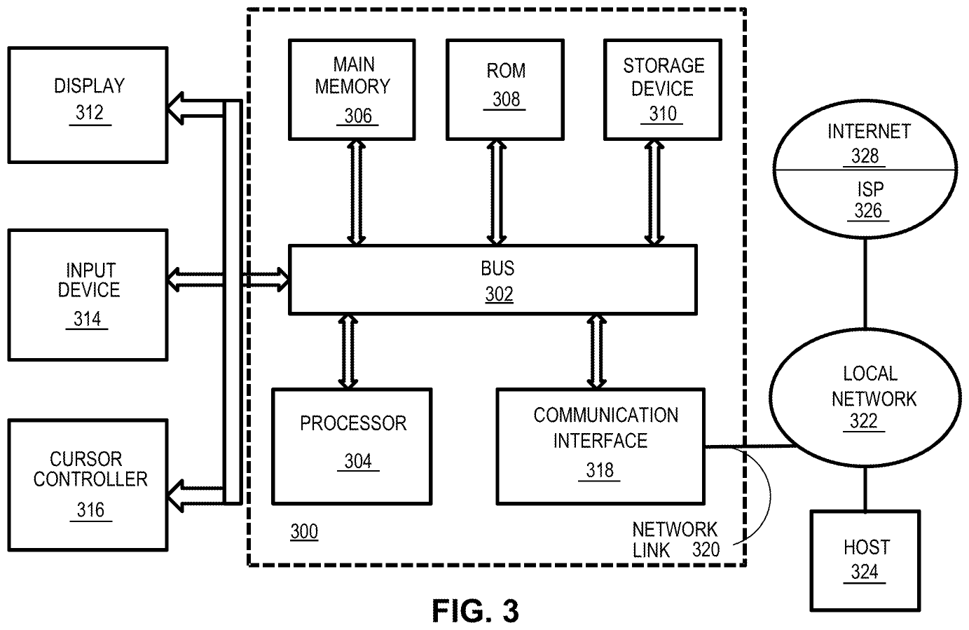

As used herein, an AV system refers to the AV along with the array of hardware, software, stored data, and data generated in real-time that supports the operation of the AV. In some embodiments, the AV system is incorporated within the AV. In some embodiments, the AV system is spread across several locations. For example, some of the software of the AV system is implemented on a cloud computing environment similar to cloud computing environment 300 described below with respect to FIG. 3.

In general, this document describes technologies applicable to any vehicles that have one or more autonomous capabilities including fully autonomous vehicles, highly autonomous vehicles, and conditionally autonomous vehicles, such as so-called Level 5, Level 4 and Level 3 vehicles, respectively (see SAE International's standard J3016: Taxonomy and Definitions for Terms Related to On-Road Motor Vehicle Automated Driving Systems, which is incorporated by reference in its entirety, for more details on the classification of levels of autonomy in vehicles). The technologies described in this document are also applicable to partially autonomous vehicles and driver assisted vehicles, such as so-called Level 2 and Level 1 vehicles (see SAE International's standard J3016: Taxonomy and Definitions for Terms Related to On-Road Motor Vehicle Automated Driving Systems). In some embodiments, one or more of the Level 1, 2, 3, 4 and 5 vehicle systems may automate certain vehicle operations (e.g., steering, braking, and using maps) under certain operating conditions based on processing of sensor inputs. The technologies described in this document can benefit vehicles in any levels, ranging from fully autonomous vehicles to human-operated vehicles.

Autonomous vehicles have advantages over vehicles that require a human driver. One advantage is safety. For example, in 2016, the United States experienced 6 million automobile accidents, 2.4 million injuries, 40,000 fatalities, and 13 million vehicles in crashes, estimated at a societal cost of $910+ billion. U.S. traffic fatalities per 100 million miles traveled have been reduced from about six to about one from 1965 to 2015, in part due to additional safety measures deployed in vehicles. For example, an additional half second of warning that a crash is about to occur is believed to mitigate 60% of front-to-rear crashes. However, passive safety features (e.g., seat belts, airbags) have likely reached their limit in improving this number. Thus, active safety measures, such as automated control of a vehicle, are the likely next step in improving these statistics. Because human drivers are believed to be responsible for a critical pre-crash event in 95% of crashes, automated driving systems are likely to achieve better safety outcomes, e.g., by reliably recognizing and avoiding critical situations better than humans; making better decisions, obeying traffic laws, and predicting future events better than humans; and reliably controlling a vehicle better than a human.

Referring to FIG. 1, an AV system 120 operates the vehicle 100 along a trajectory 198 through an environment 190 to a destination 199 (sometimes referred to as a final location) while avoiding objects (e.g., natural obstructions 191, vehicles 193, pedestrians 192, cyclists, and other obstacles) and obeying rules of the road (e.g., rules of operation or driving preferences).

In some embodiments, the AV system 120 includes devices 101 that are instrumented to receive and act on operational commands from one or more computer processors 146. We use the term “operational command” to mean an executable instruction (or set of instructions) that causes a vehicle to perform an action (e.g., a driving maneuver). Operational commands can, without limitation, including instructions for a vehicle to start moving forward, stop moving forward, start moving backward, stop moving backward, accelerate, decelerate, perform a left turn, and perform a right turn. In some embodiments, computer processor 146 is similar to the processor 304 described below in reference to FIG. 3. Examples of devices 101 include a steering control 102, brakes 103, gears, accelerator pedal or other acceleration control mechanisms, windshield wipers, side-door locks, window controls, and turn-indicators.

In some embodiments, the AV system 120 includes sensors 121 for measuring or inferring properties of state or condition of the vehicle 100, such as the AV's position, linear and angular velocity and acceleration, and heading (e.g., an orientation of the leading end of vehicle 100). Example of sensors 121 are GPS, inertial measurement units (IMU) that measure both vehicle linear accelerations and angular rates, wheel speed sensors for measuring or estimating wheel slip ratios, wheel brake pressure or braking torque sensors, engine torque or wheel torque sensors, and steering angle and angular rate sensors.

In some embodiments, the sensors 121 also include sensors for sensing or measuring properties of the AV's environment. For example, the sensors 121 include monocular or stereo video cameras 122 in the visible light, infrared or thermal (or both) spectra, LiDAR 123, RADAR, ultrasonic sensors, time-of-flight (TOF) depth sensors, speed sensors, temperature sensors, humidity sensors, and precipitation sensors.

In some embodiments, the AV system 120 includes a data storage unit 142 and memory 144 for storing machine instructions associated with computer processor 146 or data collected by sensors 121. In some embodiments, the data storage unit 142 is similar to the ROM 308 or storage device 310 described below in relation to FIG. 3. In some embodiments, memory 144 is similar to the main memory 306 described below. In some embodiments, the data storage unit 142 and memory 144 store historical, real-time, and/or predictive information about the environment 190. In some embodiments, the stored information includes maps, driving performance, traffic congestion updates or weather conditions. In some embodiments, data relating to the environment 190 is transmitted to the vehicle 100 via a communications channel from a remotely located database 134.

In some embodiments, the AV system 120 includes communications devices 140 for communicating measured or inferred properties of other vehicles' states and conditions, such as positions, linear and angular velocities, linear and angular accelerations, and linear and angular headings to the vehicle 100. These devices include Vehicle-to-Vehicle (V2V) and Vehicle-to-Infrastructure (V2I) communication devices and devices for wireless communications over point-to-point or ad hoc networks or both. In some embodiments, the communications devices 140 communicate across the electromagnetic spectrum (including radio and optical communications) or other media (e.g., air and acoustic media). A combination of Vehicle-to-Vehicle (V2V) Vehicle-to-Infrastructure (V2I) communication (and, in some embodiments, one or more other types of communication) is sometimes referred to as Vehicle-to-Everything (V2X) communication. V2X communication typically conforms to one or more communications standards for communication with, between, and among autonomous vehicles.

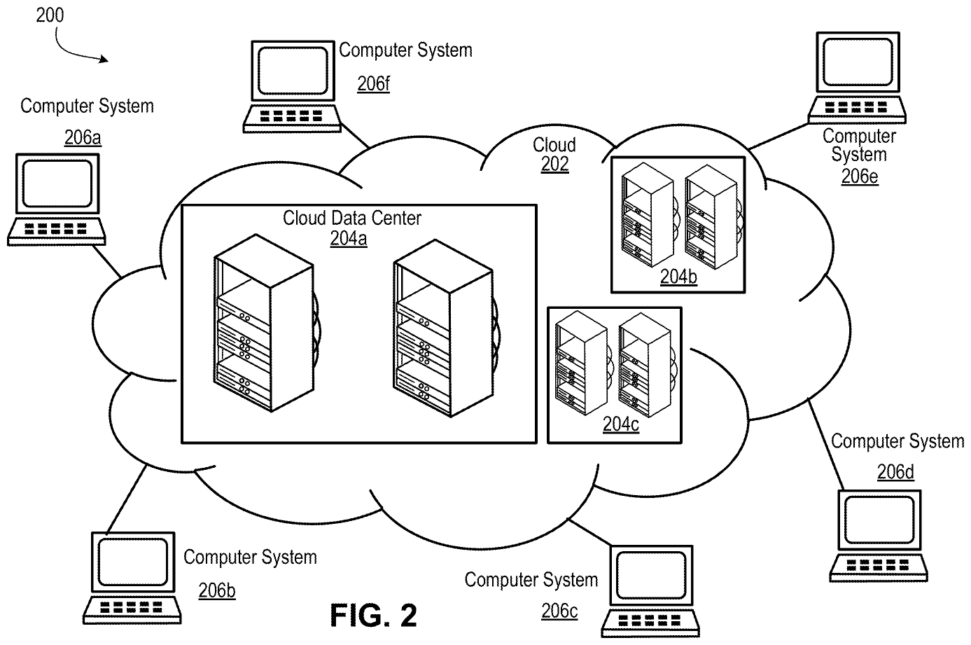

In some embodiments, the communication devices 140 include communication interfaces. For example, wired, wireless, WiMAX, Wi-Fi, Bluetooth, satellite, cellular, optical, near field, infrared, or radio interfaces. The communication interfaces transmit data from a remotely located database 134 to AV system 120. In some embodiments, the remotely located database 134 is embedded in a cloud computing environment 200 as described in FIG. 2. The communication devices 140 transmit data collected from sensors 121 or other data related to the operation of vehicle 100 to the remotely located database 134. In some embodiments, communication devices 140 transmit information that relates to teleoperations to the vehicle 100. In some embodiments, the vehicle 100 communicates with other remote (e.g., “cloud”) servers 136.

In some embodiments, the remotely located database 134 also stores and transmits digital data (e.g., storing data such as road and street locations). Such data is stored on the memory 144 on the vehicle 100, or transmitted to the vehicle 100 via a communications channel from the remotely located database 134.

In some embodiments, the remotely located database 134 stores and transmits historical information about driving properties (e.g., speed and acceleration profiles) of vehicles that have previously traveled along trajectory 198 at similar times of day. In one implementation, such data may be stored on the memory 144 on the vehicle 100, or transmitted to the vehicle 100 via a communications channel from the remotely located database 134.

Computer processors 146 located on the vehicle 100 algorithmically generate control actions based on both real-time sensor data and prior information, allowing the AV system 120 to execute its autonomous driving capabilities.

In some embodiments, the AV system 120 includes computer peripherals 132 coupled to computer processors 146 for providing information and alerts to, and receiving input from, a user (e.g., an occupant or a remote user) of the vehicle 100. In some embodiments, computer peripherals 132 are similar to the display 312, input device 314, and cursor controller 316 discussed below in reference to FIG. 3. The coupling is wireless or wired. Any two or more of the interface devices may be integrated into a single device.

In some embodiments, the AV system 120 receives and enforces a privacy level of a passenger, e.g., specified by the passenger or stored in a profile associated with the passenger. The privacy level of the passenger determines how particular information associated with the passenger (e.g., passenger comfort data, biometric data, etc.) is permitted to be used, stored in the passenger profile, and/or stored on the cloud server 136 and associated with the passenger profile. In some embodiments, the privacy level specifies particular information associated with a passenger that is deleted once the ride is completed. In some embodiments, the privacy level specifies particular information associated with a passenger and identifies one or more entities that are authorized to access the information. Examples of specified entities that are authorized to access information can include other AVs, third party AV systems, or any entity that could potentially access the information.

A privacy level of a passenger can be specified at one or more levels of granularity. In some embodiments, a privacy level identifies specific information to be stored or shared. In some embodiments, the privacy level applies to all the information associated with the passenger such that the passenger can specify that none of her personal information is stored or shared. Specification of the entities that are permitted to access particular information can also be specified at various levels of granularity. Various sets of entities that are permitted to access particular information can include, for example, other AVs, cloud servers 136, specific third party AV systems, etc.

In some embodiments, the AV system 120 or the cloud server 136 determines if certain information associated with a passenger can be accessed by the vehicle 100 or another entity. For example, a third-party AV system that attempts to access passenger input related to a particular spatiotemporal location must obtain authorization, e.g., from the AV system 120 or the cloud server 136, to access the information associated with the passenger. For example, the AV system 120 uses the passenger's specified privacy level to determine whether the passenger input related to the spatiotemporal location can be presented to the third-party AV system, the vehicle 100, or to another AV. This enables the passenger's privacy level to specify which other entities are allowed to receive data about the passenger's actions or other data associated with the passenger.

FIG. 2 illustrates an example “cloud” computing environment. Cloud computing is a model of service delivery for enabling convenient, on-demand network access to a shared pool of configurable computing resources (e.g., networks, network bandwidth, servers, processing, memory, storage, applications, virtual machines, and services). In typical cloud computing systems, one or more large cloud data centers house the machines used to deliver the services provided by the cloud. Referring now to FIG. 2, the cloud computing environment 200 includes cloud data centers 204a, 204b, and 204c that are interconnected through the cloud 202. Data centers 204a, 204b, and 204c provide cloud computing services to computer systems 206a, 206b, 206c, 206d, 206e, and 206f connected to cloud 202.

The cloud computing environment 200 includes one or more cloud data centers. In general, a cloud data center, for example the cloud data center 204a shown in FIG. 2, refers to the physical arrangement of servers that make up a cloud, for example the cloud 202 shown in FIG. 2, or a particular portion of a cloud. For example, servers are physically arranged in the cloud datacenter into rooms, groups, rows, and racks. A cloud datacenter has one or more zones, which include one or more rooms of servers. Each room has one or more rows of servers, and each row includes one or more racks. Each rack includes one or more individual server nodes. In some implementation, servers in zones, rooms, racks, and/or rows are arranged into groups based on physical infrastructure requirements of the datacenter facility, which include power, energy, thermal, heat, and/or other requirements. In some embodiments, the server nodes are similar to the computer system described in FIG. 3. The data center 204a has many computing systems distributed through many racks.

The cloud 202 includes cloud data centers 204a, 204b, and 204c along with the network and networking resources (for example, networking equipment, nodes, routers, switches, and networking cables) that interconnect the cloud data centers 204a, 204b, and 204c and help facilitate the computing systems' 206a-f access to cloud computing services. In some embodiments, the network represents any combination of one or more local networks, wide area networks, or internetworks coupled using wired or wireless links deployed using terrestrial or satellite connections. Data exchanged over the network, is transferred using any number of network layer protocols, such as Internet Protocol (IP), Multiprotocol Label Switching (MPLS), Asynchronous Transfer Mode (ATM), Frame Relay, etc. Furthermore, in embodiments where the network represents a combination of multiple sub-networks, different network layer protocols are used at each of the underlying sub-networks. In some embodiments, the network represents one or more interconnected internetworks, such as the public Internet.

The computing systems 206a-f or cloud computing services consumers are connected to the cloud 202 through network links and network adapters. In some embodiments, the computing systems 206a-f are implemented as various computing devices, for example servers, desktops, laptops, tablet, smartphones, Internet of Things (IoT) devices, autonomous vehicles (including, cars, drones, shuttles, trains, buses, etc.) and consumer electronics. In some embodiments, the computing systems 206a-f are implemented in or as a part of other systems.

FIG. 3 illustrates a computer system 300. In an implementation, the computer system 300 is a special purpose computing device. The special-purpose computing device is hard-wired to perform the techniques or includes digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. In various embodiments, the special-purpose computing devices are desktop computer systems, portable computer systems, handheld devices, network devices or any other device that incorporates hard-wired and/or program logic to implement the techniques.

In some embodiments, the computer system 300 includes a bus 302 or other communication mechanism for communicating information, and a hardware processor 304 coupled with a bus 302 for processing information. The hardware processor 304 is, for example, a general-purpose microprocessor. The computer system 300 also includes a main memory 306, such as a random-access memory (RAM) or other dynamic storage device, coupled to the bus 302 for storing information and instructions to be executed by processor 304. In one implementation, the main memory 306 is used for storing temporary variables or other intermediate information during execution of instructions to be executed by the processor 304. Such instructions, when stored in non-transitory storage media accessible to the processor 304, render the computer system 300 into a special-purpose machine that is customized to perform the operations specified in the instructions.

In some embodiments, the computer system 300 further includes a read only memory (ROM) 308 or other static storage device coupled to the bus 302 for storing static information and instructions for the processor 304. A storage device 310, such as a magnetic disk, optical disk, solid-state drive, or three-dimensional cross point memory is provided and coupled to the bus 302 for storing information and instructions.

In some embodiments, the computer system 300 is coupled via the bus 302 to a display 312, such as a cathode ray tube (CRT), a liquid crystal display (LCD), plasma display, light emitting diode (LED) display, or an organic light emitting diode (OLED) display for displaying information to a computer user. An input device 314, including alphanumeric and other keys, is coupled to bus 302 for communicating information and command selections to the processor 304. Another type of user input device is a cursor controller 316, such as a mouse, a trackball, a touch-enabled display, or cursor direction keys for communicating direction information and command selections to the processor 304 and for controlling cursor movement on the display 312. This input device typically has two degrees of freedom in two axes, a first axis (e.g., x-axis) and a second axis (e.g., y-axis), that allows the device to specify positions in a plane.

According to one embodiment, the techniques herein are performed by the computer system 300 in response to the processor 304 executing one or more sequences of one or more instructions contained in the main memory 306. Such instructions are read into the main memory 306 from another storage medium, such as the storage device 310. Execution of the sequences of instructions contained in the main memory 306 causes the processor 304 to perform the process steps described herein. In alternative embodiments, hard-wired circuitry is used in place of or in combination with software instructions.

The term “storage media” as used herein refers to any non-transitory media that store data and/or instructions that cause a machine to operate in a specific fashion. Such storage media includes non-volatile media and/or volatile media. Non-volatile media includes, for example, optical disks, magnetic disks, solid-state drives, or three-dimensional cross point memory, such as the storage device 310. Volatile media includes dynamic memory, such as the main memory 306. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NV-RAM, or any other memory chip or cartridge.

Storage media is distinct from but may be used in conjunction with transmission media. Transmission media participates in transferring information between storage media. For example, transmission media includes coaxial cables, copper wire and fiber optics, including the wires that comprise the bus 302. Transmission media can also take the form of acoustic or light waves, such as those generated during radio-wave and infrared data communications.

In some embodiments, various forms of media are involved in carrying one or more sequences of one or more instructions to the processor 304 for execution. For example, the instructions are initially carried on a magnetic disk or solid-state drive of a remote computer. The remote computer loads the instructions into its dynamic memory and send the instructions over a telephone line using a modem. A modem local to the computer system 300 receives the data on the telephone line and use an infrared transmitter to convert the data to an infrared signal. An infrared detector receives the data carried in the infrared signal and appropriate circuitry places the data on the bus 302. The bus 302 carries the data to the main memory 306, from which processor 304 retrieves and executes the instructions. The instructions received by the main memory 306 may optionally be stored on the storage device 310 either before or after execution by processor 304.

The computer system 300 also includes a communication interface 318 coupled to the bus 302. The communication interface 318 provides a two-way data communication coupling to a network link 320 that is connected to a local network 322. For example, the communication interface 318 is an integrated service digital network (ISDN) card, cable modem, satellite modem, or a modem to provide a data communication connection to a corresponding type of telephone line. As another example, the communication interface 318 is a local area network (LAN) card to provide a data communication connection to a compatible LAN. In some implementations, wireless links are also implemented. In any such implementation, the communication interface 318 sends and receives electrical, electromagnetic, or optical signals that carry digital data streams representing various types of information.

The network link 320 typically provides data communication through one or more networks to other data devices. For example, the network link 320 provides a connection through the local network 322 to a host computer 324 or to a cloud data center or equipment operated by an Internet Service Provider (ISP) 326. The ISP 326 in turn provides data communication services through the world-wide packet data communication network now commonly referred to as the “Internet” 328. The local network 322 and Internet 328 both use electrical, electromagnetic or optical signals that carry digital data streams. The signals through the various networks and the signals on the network link 320 and through the communication interface 318, which carry the digital data to and from the computer system 300, are example forms of transmission media. In some embodiments, the network 320 contains the cloud 202 or a part of the cloud 202 described above.

The computer system 300 sends messages and receives data, including program code, through the network(s), the network link 320, and the communication interface 318. In some embodiments, the computer system 300 receives code for processing. The received code is executed by the processor 304 as it is received, and/or stored in storage device 310, or other non-volatile storage for later execution.

### Autonomous Vehicle Architecture

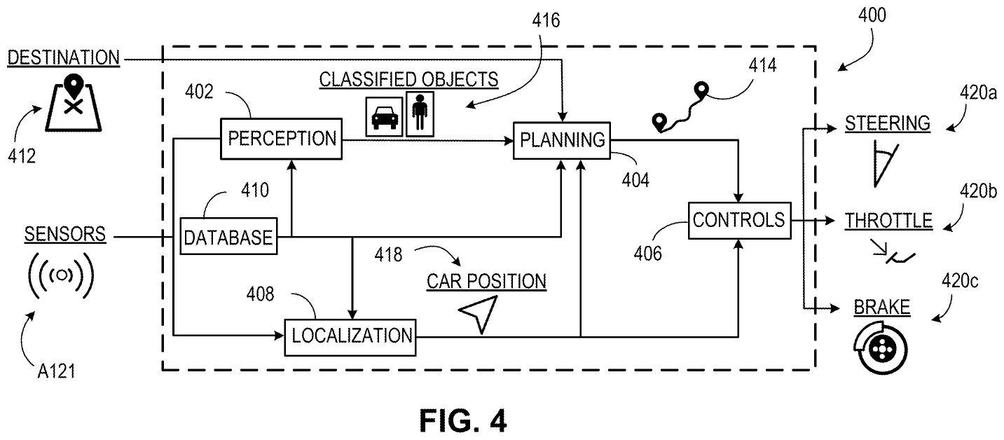

FIG. 4 shows an example architecture 400 for an autonomous vehicle (e.g., the vehicle 100 shown in FIG. 1). The architecture 400 includes a perception module 402 (sometimes referred to as a perception circuit), a planning module 404 (sometimes referred to as a planning circuit), a control module 406 (sometimes referred to as a control circuit), a localization module 408 (sometimes referred to as a localization circuit), and a database module 410 (sometimes referred to as a database circuit). Each module plays a role in the operation of the vehicle 100. Together, the modules 402, 404, 406, 408, and 410 may be part of the AV system 120 shown in FIG. 1. In some embodiments, any of the modules 402, 404, 406, 408, and 410 is a combination of computer software (e.g., executable code stored on a computer-readable medium) and computer hardware (e.g., one or more microprocessors, microcontrollers, application-specific integrated circuits [ASICs]), hardware memory devices, other types of integrated circuits, other types of computer hardware, or a combination of any or all of these things). Each of the modules 402, 404, 406, 408, and 410 is sometimes referred to as a processing circuit (e.g., computer hardware, computer software, or a combination of the two). A combination of any or all of the modules 402, 404, 406, 408, and 410 is also an example of a processing circuit.

In use, the planning module 404 receives data representing a destination 412 and determines data representing a trajectory 414 (sometimes referred to as a route) that can be traveled by the vehicle 100 to reach (e.g., arrive at) the destination 412. In order for the planning module 404 to determine the data representing the trajectory 414, the planning module 404 receives data from the perception module 402, the localization module 408, and the database module 410.

The perception module 402 identifies nearby physical objects using one or more sensors 121, e.g., as also shown in FIG. 1. The objects are classified (e.g., grouped into types such as pedestrian, bicycle, automobile, traffic sign, etc.) and a scene description including the classified objects 416 is provided to the planning module 404.

The planning module 404 also receives data representing the AV position 418 from the localization module 408. The localization module 408 determines the AV position by using data from the sensors 121 and data from the database module 410 (e.g., a geographic data) to calculate a position. For example, the localization module 408 uses data from a GNSS (Global Navigation Satellite System) sensor and geographic data to calculate a longitude and latitude of the AV. In some embodiments, data used by the localization module 408 includes high-precision maps of the roadway geometric properties, maps describing road network connectivity properties, maps describing roadway physical properties (such as traffic speed, traffic volume, the number of vehicular and cyclist traffic lanes, lane width, lane traffic directions, or lane marker types and locations, or combinations of them), and maps describing the spatial locations of road features such as crosswalks, traffic signs or other travel signals of various types. In some embodiments, the high-precision maps are constructed by adding data through automatic or manual annotation to low-precision maps.

The control module 406 receives the data representing the trajectory 414 and the data representing the AV position 418 and operates the control functions 420a-c (e.g., steering, throttling, braking, ignition) of the AV in a manner that will cause the vehicle 100 to travel the trajectory 414 to the destination 412. For example, if the trajectory 414 includes a left turn, the control module 406 will operate the control functions 420a-c in a manner such that the steering angle of the steering function will cause the vehicle 100 to turn left and the throttling and braking will cause the vehicle 100 to pause and wait for passing pedestrians or vehicles before the turn is made.

### Autonomous Vehicle Inputs

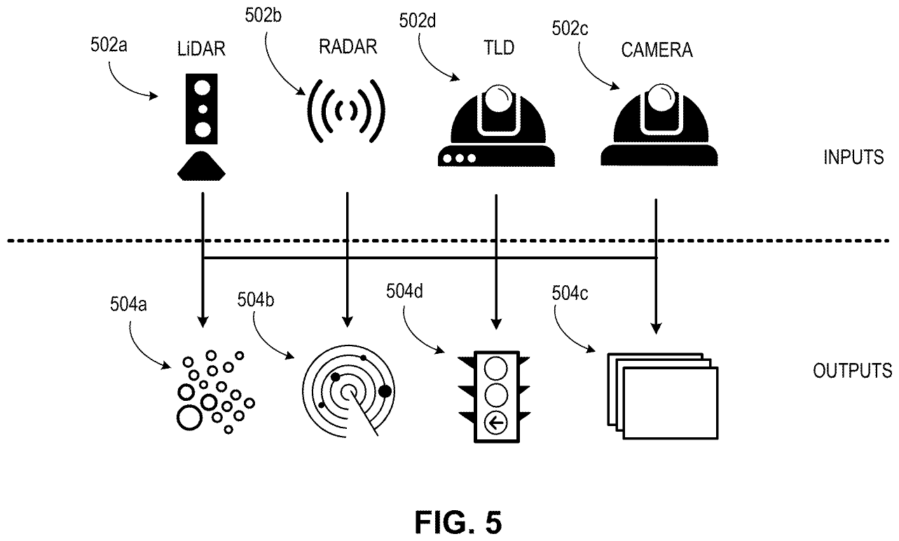

FIG. 5 shows an example of inputs 502a-d (e.g., sensors 121 shown in FIG. 1) and outputs 504a-d (e.g., sensor data) that is used by the perception module 402 (FIG. 4). One input 502a is a LiDAR (Light Detection and Ranging) system (e.g., LiDAR 123 shown in FIG. 1). LiDAR is a technology that uses light (e.g., bursts of light such as infrared light) to obtain data about physical objects in its line of sight. A LiDAR system produces LiDAR data as output 504a. For example, LiDAR data is collections of 3D or 2D points (also known as a point clouds) that are used to construct a representation of the environment 190.

Another input 502b is a RADAR system. RADAR is a technology that uses radio waves to obtain data about nearby physical objects. RADARs can obtain data about objects not within the line of sight of a LiDAR system. A RADAR system 502b produces RADAR data as output 504b. For example, RADAR data are one or more radio frequency electromagnetic signals that are used to construct a representation of the environment 190.

Another input 502c is a camera system. A camera system uses one or more cameras (e.g., digital cameras using a light sensor such as a charge-coupled device [CCD]) to obtain information about nearby physical objects. A camera system produces camera data as output 504c. Camera data often takes the form of image data (e.g., data in an image data format such as RAW, JPEG, PNG, etc.). In some examples, the camera system has multiple independent cameras, e.g., for the purpose of stereopsis (stereo vision), which enables the camera system to perceive depth. Although the objects perceived by the camera system are described here as “nearby,” this is relative to the AV. In use, the camera system may be configured to “see” objects far, e.g., up to a kilometer or more ahead of the AV. Accordingly, the camera system may have features such as sensors and lenses that are optimized for perceiving objects that are far away.

Another input 502d is a traffic light detection (TLD) system. A TLD system uses one or more cameras to obtain information about traffic lights, street signs, and other physical objects that provide visual navigation information. A TLD system produces TLD data as output 504d. TLD data often takes the form of image data (e.g., data in an image data format such as RAW, JPEG, PNG, etc.). A TLD system differs from a system incorporating a camera in that a TLD system uses a camera with a wide field of view (e.g., using a wide-angle lens or a fish-eye lens) in order to obtain information about as many physical objects providing visual navigation information as possible, so that the vehicle 100 has access to all relevant navigation information provided by these objects. For example, the viewing angle of the TLD system may be about 120 degrees or more.

In some embodiments, outputs 504a-d are combined using a sensor fusion technique. Thus, either the individual outputs 504a-d are provided to other systems of the vehicle 100 (e.g., provided to a planning module 404 as shown in FIG. 4), or the combined output can be provided to the other systems, either in the form of a single combined output or multiple combined outputs of the same type (e.g., using the same combination technique or combining the same outputs or both) or different types type (e.g., using different respective combination techniques or combining different respective outputs or both). In some embodiments, an early fusion technique is used. An early fusion technique is characterized by combining outputs before one or more data processing steps are applied to the combined output. In some embodiments, a late fusion technique is used. A late fusion technique is characterized by combining outputs after one or more data processing steps are applied to the individual outputs.

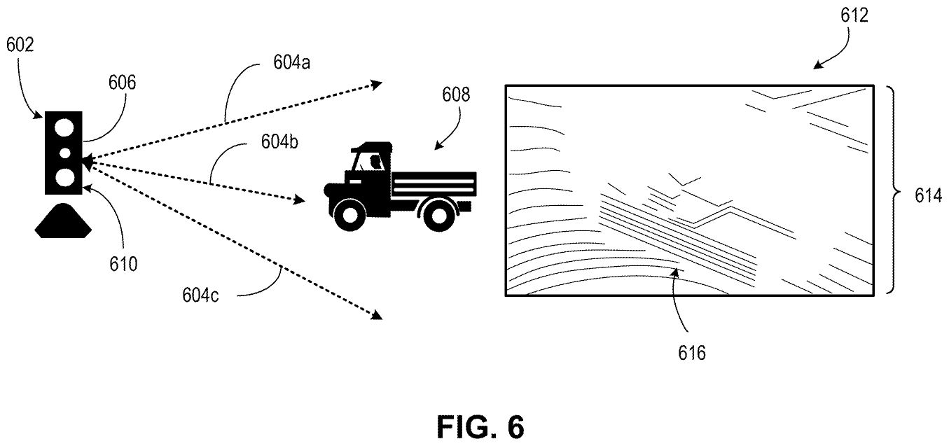

FIG. 6 shows an example of a LiDAR system 602 (e.g., the input 502a shown in FIG. 5). The LiDAR system 602 emits light 604a-c from a light emitter 606 (e.g., a laser transmitter). Light emitted by a LiDAR system is typically not in the visible spectrum; for example, infrared light is often used. Some of the light 604b emitted encounters a physical object 608 (e.g., a vehicle) and reflects back to the LiDAR system 602. (Light emitted from a LiDAR system typically does not penetrate physical objects, e.g., physical objects in solid form.) The LiDAR system 602 also has one or more light detectors 610, which detect the reflected light. In some embodiments, one or more data processing systems associated with the LiDAR system generates an image 612 representing the field of view 614 of the LiDAR system. The image 612 includes information that represents the boundaries 616 of a physical object 608. In this way, the image 612 is used to determine the boundaries 616 of one or more physical objects near an AV.

### Autonomous Vehicle Security Gateway

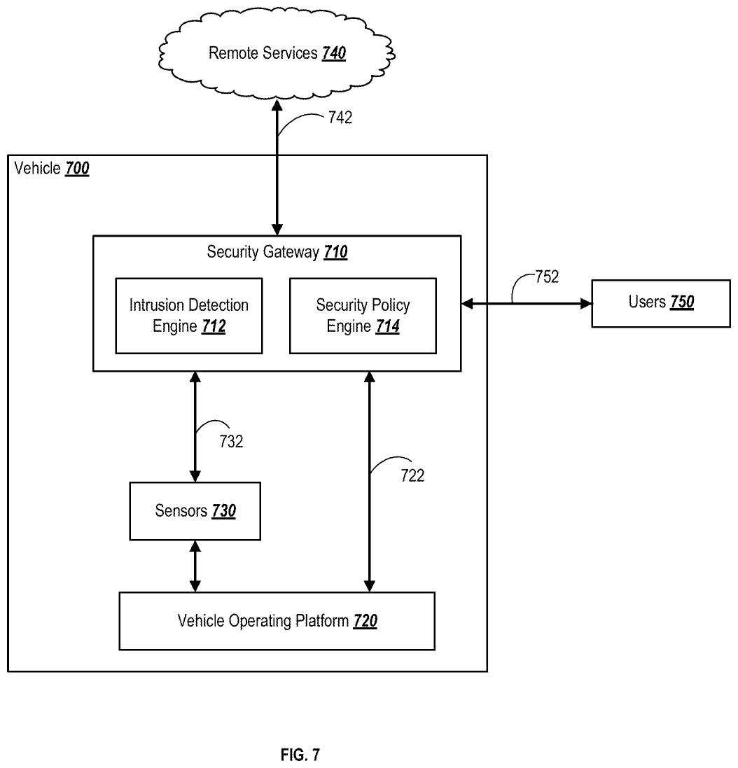

FIG. 7 shows an example of a vehicle 700 having a security gateway 710. The vehicle 700 also includes a vehicle operating platform 720 and one or more sensors, collectively represented as sensors 730. The security gateway 710 includes an intrusion detection engine 712, and a security policy engine 714. The security gateway 710 and other devices in the vehicle 700, such as the sensors 730, communicate with one or more remote services 740, and one or more users 750.

In some embodiments, the vehicle 700 is an example of the vehicle 100 (FIG. 1). In such cases, the vehicle operating platform 720 corresponds to the hardware and software for operating the devices in the vehicle. These include, among others, processors 146, devices 101 (e.g., one of steering control 102 or brakes 103, among others), computer peripherals 132, data storage unit 142 and memory 144. The sensors 730 correspond to the sensors 121, such as one of monocular or stereo video cameras 122, infrared or thermal (or both) spectra, LiDAR 123, RADAR, ultrasonic sensors, time-of-flight (TOF) depth sensors, speed sensors, temperature sensors, humidity sensors, or precipitation sensors. In some embodiments, the sensors 730 also include the AV software stack for operating the sensors 730. In some embodiments, the security gateway 710 corresponds to, or is included in, the communications devices 140. In other embodiments, the security gateway 710 is a separate hardware component that is coupled to the communications devices 140, monitoring and managing all traffic that passes between the communications devices 140 and other components in the vehicle 100. The vehicle operating platform 720, the sensors 730, and the security gateway 710 are collectively part of the AV system 120 in the vehicle 100. Without loss of generality, the following sections describe the security gateway 710 with respect to the vehicle 100 where applicable.

In some embodiments, the security gateway 710 provides the functionality of a router, a switch, or a firewall, or any combination of these, in the vehicle 700. All communication traffic going in to, or out from, the vehicle is examined by the security gateway 710. For example, the security gateway 710 monitors all inward traffic that are received by the communications device 140, and determines, based on security policies of the vehicle or known profiles of different devices in the vehicle, whether to allow or forego allowing (e.g., drop) the traffic. Similarly, the security gateway 710 monitors all outward traffic from the devices in the vehicle and destined for external entities, and determines, based on security policies of the vehicle or known profiles of different devices in the vehicle, whether to allow or forego allowing the traffic. In some embodiments, the security gateway 710 also monitors internal traffic between components of the vehicle, for example, between the sensors 121 and the processors 146, among others.

In some embodiments, the remote services 740 include network servers associated with a remote vehicle administration center, such as network servers used to send configuration updates to the vehicle 700, or control operation of the vehicle. In such cases, communication traffic 742 with the remote services 740 includes vehicle telemetry, remote administration requests, vehicle deployment requests and information, dispatch commands, or remote operator feeds, among others.

In some embodiments, the users 750 include riders in the vehicle 700. In such cases, communication traffic 752 with the users 750 include control requests from the riders, vehicle pull-over requests, or content entered through a vehicle user interface (e.g., a dashboard display), among others. Additionally or alternatively, in some embodiments, the users 750 include other vehicles on the roadway (e.g., vehicles 193 as shown in FIG. 1) and/or their riders. In such cases, communication traffic 752 include communication to coordinate movement of the vehicle 700 and the other vehicles sharing the roadway, among others. Additionally or alternatively, in some embodiments, the users 750 include a safety steward/operator of the vehicle 700. In such cases, the communication traffic 752 include safe stop requests, commands to engage driver mode or driverless mode, emergency stop commands, commands to engage automatic mode or manual mode, among others.

The security gateway 710 examines all communication traffic 742 or communication traffic 752, or both, and allows or blocks the traffic as appropriate depending on the security policies for the various devices in the vehicle 700. As noted above, the security gateway 710 also examines traffic generated within the vehicle 700. This includes communication traffic 722 with the vehicle operating platform 720, or the communication traffic 732 with the sensors 730, or both. In some embodiments, the communication traffic 722 include vehicle operation data (e.g., speed or movement direction), state of vehicle body functions (e.g., state of the windows or door locks), among others. The communication traffic 732 include camera feeds from vehicle cameras (e.g., video cameras 122), planned trajectory, vehicle telemetry, sensor-generated safe stop or pullover command, or sensor data on body controls, among others.

In some embodiments, the intrusion detection engine 712 is realized as hardware circuitry in the security gateway 710. In some examples, the intrusion detection engine 712 is implemented using an ASIC, a microprocessor and/or a microcontroller. In some embodiments, the intrusion detection engine 712 is realized as a software instructions that are encoded in memory storage (e.g., a RAM and/or a nonvolatile storage) in the security gateway, with a processor executing the instructions to perform operations of the intrusion detection engine 712.

In some embodiments, the policy engine 714 is realized as hardware circuitry in the security gateway 710. In some examples, the policy engine 714 is implemented using an ASIC, a microprocessor and/or a microcontroller. In some embodiments, the policy engine 714 is realized as a software instructions that are encoded in memory storage (e.g., a RAM and/or a nonvolatile storage) in the security gateway, with a processor executing the instructions to perform operations of the policy engine 714. In some embodiments, the intrusion detection engine 712 and the policy engine 714 are configured to communicate with one another to coordinate their respective operations for performing the functions of the security gateway 710.

In some embodiments, the intrusion detection engine 712 detects evidence of security attacks, such as behavioral abnormalities in operations of one or more devices in the vehicle 700 that are compromised by an external adversary. For example, in some cases, a comprised update server associated with an external adversary sends a rogue configuration update for one or more sensors 730. The configuration update is intended to change the configuration of the sensors 730 such that they stop providing environmental data for the operation of the vehicle 700, or provide incorrect data (e.g., reporting inaccurate blind spot objects). The intrusion detection engine 712 is configured to identify such abnormal behavior (and flag such abnormal behavior for the vehicle operator/administrator to take corrective actions), and block operations of the compromised device, or communication from the compromised device to other components in the vehicle, to prevent the compromised device from affecting the safety and overall security of the vehicle 700.

In some embodiments, the intrusion detection engine 712 checks indicators associated with devices that have low computational overhead. For example, in some cases, the security gateway 710 stores information (or access information stored, for example, in the storage unit 142 or memory 144) about typical (for example, mean and standard deviations) electric current consumption profiles of the component devices in the vehicle 700, such as the processor 146, the devices 101, or the sensors 121. The intrusion detection engine 712 compares a device's current consumption at a present time instant to the typical current profile of the device, and determines whether the device's current consumption has deviated from its typical profile. In some embodiments, a significant deviation in the present current consumption, e.g., the current consumption being much higher than typical, indicates an abnormal condition, such as processing a high volume of messages due to a distributed denial of service (DDoS) security attack.

As another example, in some cases, the security gateway 710 stores or accesses information about typical traffic profiles of the component devices in the vehicle, which can include mean values of frequency of messages, message sizes, error rates, or response latency, among others, along with corresponding standard deviations. The intrusion detection engine 712 compares a traffic profile of a device at a present time instant to the typical traffic profile of the device to determine whether there is a deviation that would indicate a security breach. For example, a frequency of messages received at the communications device 140 that is significantly higher than the mean value of received message frequency at the communications device 140, and beyond the standard deviation, could indicate a DDoS attack.

As yet another example, in some cases, the security gateway 710 stores or accesses information about typical behavior profiles of the component devices in the vehicle 700. The behavior profiles include vehicle speed, spin speed of LiDAR sensors, operating temperature of processors (e.g., processor 146), typical usage of device memory (e.g., memory 144), or file input/output (I/O), among others. The intrusion detection engine 712 compares the behavior profile of a device at a present time instant to the typical behavior profile of the device to determine a deviation, if any. For example, following a remote configuration update of a LiDAR sensor, a very high spin speed of the sensor that is beyond the standard deviation of the typical value can indicate that the new configuration was erroneous, and possibly malicious. Other device profiles and corresponding intrusion detection engine tasks are possible in various embodiments.

In some embodiments, upon detecting one or more abnormalities, such as those exemplified above, the intrusion detection engine 712 blocks communication traffic that is associated with the detected abnormalities, and flags the issue. For example, in some cases, the intrusion detection engine 712 sends an alert to AV system in the vehicle 700, or the operator/administrator of the vehicle 700, or both. In some embodiments, depending on the severity of the flagged abnormalities, the AV system and/or the operator shuts down the affected devices, or cause the vehicle to come to an emergency stop. Other actions are also possible in various embodiments.

In some embodiments, the security policy engine 714 manages and enforces security policies for the component devices in the vehicle 700. As described previously, the collection of security policies in the vehicle 700 act as a whitelist for the component devices in the vehicle. Any task that is specified by a security policy is allowed, while a task that is not specified by any security policy is denied.

The policy engine 714 determines which policies to use in a particular situation, and enforces these policies. As described by the examples below, depending on the source or the destination of communication traffic, or the information included in the communication traffic, the policy engine 714 determines which security policies to apply. The policy engine 714 collects data to decide what operations are allowed and then alters system state to enforce the decision (e.g., changing firewall rules to permit or block communication traffic, or enabling/disabling physical ports, among others).

As an example, in some cases, a security policy includes a cryptographic digital security certificate (e.g., an X.509 security certificate) of a trusted network server (e.g., a network server corresponding to remote services 740) from which firmware updates for the component devices in the vehicle are allowed. Additionally or alternatively, in some cases, the security policy specifies a moving speed of the vehicle 700 at which updates are allowed, e.g., that the vehicle has to be in a stopped state for one or more components in the vehicle to be updated. Based on this security policy, the policy engine 714 allows components in the vehicle to be updated only when a configuration update is received from the trusted network server, and the vehicle 700 is stopped. The policy engine 714 checks that the configuration update is received from the trusted network server by authenticating update messages that are received based on the accompanying message signatures, using a cryptographic authentication protocol and the digital certificate of the network server. Firmware updates from other sources (e.g., firmware updates that cannot be authenticated as coming from a trusted update server), or when the vehicle is moving, or both, would be blocked by the policy engine 714.

As another example, in some cases, a security policy specifies data flow directionality for each physical port in the vehicle 700. The security policy governs that physical ports assigned to a human-machine interface (HMI, such as a dashboard display in the vehicle) only allow traffic to flow to the HMI (for example, by enabling an outgoing network data diode) and not from the HMI to any other device. In doing so, the security policy ensures that the HMI is only able to receive inputs from other devices in the vehicle, and display corresponding information to the user/administrator. In such cases, the policy engine 714 blocks inputs that are received through the HMI from a user that can override preconfigured tasks of the devices.

As another example, in some cases, a security policy includes a cryptographic digital certificate (e.g., an X.509 certificate) per physical port of the AV system in the vehicle 700, binding different component devices to different physical ports for communication. Based on this security policy, the policy engine 714 allows a component device to communicate using only the physical port that is assigned to the component device by the corresponding digital certificate.

As another example, in some cases, a security policy specifies the communication protocols that are allowed based on a state of the AV system in the vehicle 700. For example, in some cases, configuration updates for component devices in the vehicle can be transmitted using only Hypertext Transfer Protocol Secure (HTTPS). In such cases, the security policy can specify that, when the vehicle is in a set-up mode, only HTTPS is allowed as the communication protocol.

As another example, in some cases, a security policy includes cryptographic digital certificate(s) (e.g., an X.509 certificate) for component devices that are allowed to communicate with the cleaning system of a sensor (e.g., sensors 121) in the vehicle and require that all messages to the cleaning system have to be authenticated using these certificate(s). The policy engine 714 uses this security policy to allow only those commands to the cleaning system that are authenticated based on the corresponding digital certificate; commands that cannot be authenticated are blocked.

The policy engine 714 enforces security policies for the vehicle 700, such as those described above. The policy engine 714 determines which policies to use in a particular situation, and enforces these policies. The policy engine 714 collects data to decide what operations are allowed and then alters system state to enforce the decision (e.g., changing firewall rules to permit or block communication traffic, or enabling/disabling physical ports, among others).

In some embodiments, upon detecting one or more abnormalities, such as those exemplified above, the policy engine 714 flags the issue, in addition to enforcing the security policies. For example, in some cases, the policy engine 714 sends an alert to AV system in the vehicle 700, or the operator/administrator of the vehicle 700, or both. In some embodiments, depending on the severity of the flagged abnormalities, the AV system and/or the operator shuts down the affected devices, or causes the vehicle to come to an emergency stop. Other actions are also possible in various embodiments.

As described previously, in some embodiments, security policies for the vehicle 700 are configurable (for example, by an operator or administrator of the vehicle) and are stored in memory (which is accessible by the policy engine) as a digitally signed electronic file. The memory can be internal to the security gateway 710, or other memory in the vehicle 700, such as memory 144. In some embodiments, the operator/administrator updates the security policies as needed. For example, the operator/administrator can add new security policies (for example, to specify new tasks to be performed by existing devices or new devices added to the vehicle), modify one or more existing security policies (for example, by adding or deleting tasks specified by a policy, or changing the device(s) that are governed by the policy), or delete existing security policies, or any suitable combination of these. In this manner, the policy engine 714 is configured to be flexible. This can be useful, for example, to facilitate addition of security controls in front of devices in the vehicle 700 that are not capable of implementing the controls themselves (e.g., a low power, low performance sensor).

In some embodiments, the policy engine 714 enforces one or more security policies for each physical port in the vehicle 700. If a port has no defined policy, then the policy engine 714 applies a default security policy to the port, which can be, for example, either to deny all communication traffic, or allow all communication traffic.

In some embodiments, the security policies in the vehicle 700 are enforced in a distributed manner. For example, the security policies can be enforced by server(s) in the remote services 740, or the policy engine 714, or a suitable combination of both. In embodiments that use a combination of the policy engine 714 and one or more remote network servers, a subset of policies decisions are made using the remote network servers, while other policy decisions are made using the policy engine 714. For example, in some cases, more compute-intensive security policies are determined and enforced using the remote network servers, which can have higher computational resources compared to the policy engine 714.

In some embodiments, the intrusion detection engine 712 and the policy engine 714 work in tandem to manage security for component devices in the vehicle 700. In such cases, upon receiving communication traffic for a device in the vehicle, the policy engine 714 checks whether the communication traffic satisfies one or more security policies that are applicable under the circumstances. The intrusion detection engine 712 determines whether the communication traffic follows the typical traffic profile for the device, or deviates from the typical traffic profile by a margin that is greater than the standard deviation. Additionally or alternatively, the intrusion detection engine 712 checks whether one or more indicators corresponding to the target device, or a behavior profile of the target device, deviates from the expected values beyond a threshold (e.g., beyond the standard deviation) upon processing the communication traffic. If the checks by the policy engine 714 and the intrusion detection engine 712 satisfy the applicable security policies and the traffic profiles, respectively, then the communication traffic is allowed to be transmitted to the target device. If either check fails, then the communication traffic is blocked.

As an illustrative example, when configuration update messages are received for one or more sensors in the vehicle from a network server, the policy engine 714 checks whether the network server is an authorized update server, by authenticating the update messages using the digital certificate of an authorized network update server. When the configuration of a sensor is updated based on the configuration update messages (for example, if the check by the policy engine 714 indicates that the messages are from an authorized server), the intrusion detection engine 712 checks whether various indicators related to the operation of the sensor are within the range of typical values. This can include, for example, comparing the current consumption of the sensor to the typical current profile, or the sensor is generating sensor data as expected, among others. If the check by the policy engine 714, or the intrusion detection engine 712, or both, indicate abnormal results, then the security gateway 710 blocks further configuration update messages from the network server, and alerts the operator/administrator. The checks can fail, for example, when the network server is compromised by a malicious adversary, or the secure configuration update messages are spoofed (e.g., due to a security replay attack), among others.

In some embodiments, the policy engine 714 performs its security checks, followed by the intrusion detection engine 712. In some embodiments, the order of operations by the policy engine 714 and the intrusion detection engine 712 are reversed. In some embodiments, the policy engine 714 and the intrusion detection engine 712 perform their checks in parallel.

### Example Processes for Managing Vehicle Security Using a Security Gateway

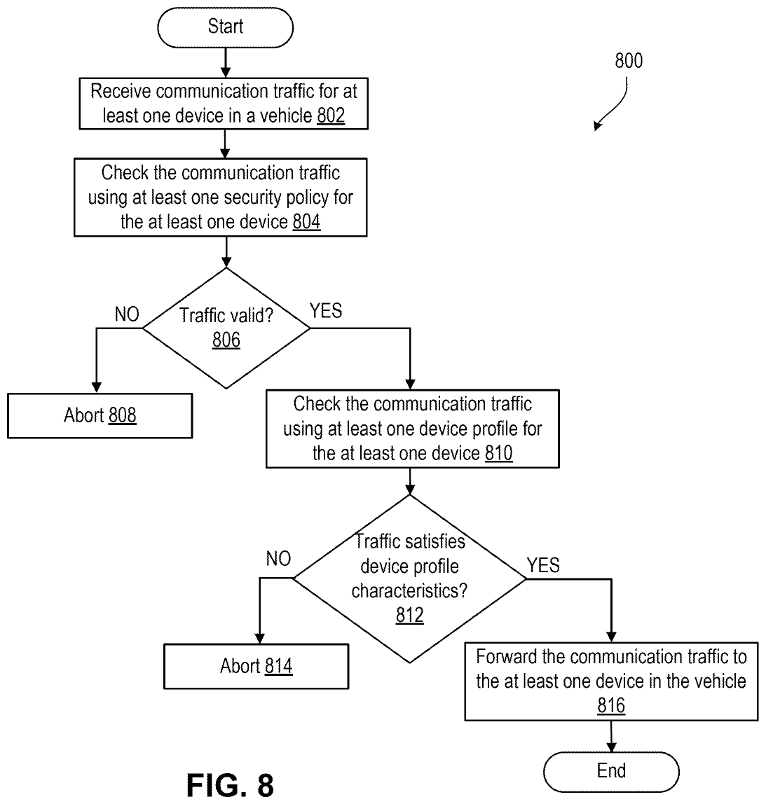

FIG. 8 shows an example process 800 for managing security in a vehicle using a security gateway deployed in the vehicle. In some embodiments, the process 800 is performed by the security gateway 710 that is deployed in a vehicle 700 to monitor and administer communication traffic exchanged between one or more devices in the vehicle 700 and external entities, such as other remote network servers or other vehicles. Accordingly, the process 800 is described in the following sections with respect to the security gateway 710, and in particular, with respect to the intrusion detection engine 712 and the policy engine 714 included in the security gateway 710. However, the process 800 can also be performed by other devices. As described previously, in some embodiments, the vehicle 700 is similar to the vehicle 100. Accordingly, in describing the process 800 with respect to the security gateway 710, references are made to hardware components of the device 100 where applicable.

The process 800 starts with the security gateway in the vehicle receiving communication traffic for at least one device in the vehicle (802). For example, the security gateway 710 receives communication traffic from an external entity for one or more devices in the vehicle 700, such as configuration update messages for the sensors 730 from a remote network server of the remote services 740. In some cases, the security gateway obtains identifiers of one or mode devices from information included in the communication traffic. For example, the security gateway 710 can determine, based on information in a configuration update message received from a remote network server of the remote services 740, that the configuration update is for one or more sensors of the sensors 730.

The process 800 continues with the security gateway checking the communication traffic using at least one security policy for the at least one device (804). For example, upon receiving the configuration update message in the example above, the policy engine 714 accesses from storage one or more security policies corresponding to the one or more sensors identified using the information in the configuration update message. The security policies specify the identity and corresponding digital security certificate of a trusted network entity, e.g., a network update server, which is authorized to update the firmware of the target sensor(s). The policy engine 714 checks whether the configuration update message is signed by the trusted network update server using the server's cryptographic key (e.g., private key of a public-private key pair, where the public key is bound to the server's identity in the digital certificate).

By checking the communication traffic using at least one security policy for the at least one device, the security gateway determines whether the communication traffic is valid (806). For example, based on the one or more security policies of the target sensor(s), the policy engine 714 verifies the signature in the configuration update message using the digital certificate of the server, following a cryptographic authentication/verification protocol. In some cases, the policy engine 714 determines, using the one or more security policies, a security certificate of the trusted network entity (e.g., the network update server) that is authorized to update the functionality of the target devices, e.g., the one or more sensor(s). If the communication traffic is successfully authenticated based at least on the security certificate of the trusted network entity, then the policy engine 714 determines that the communication traffic is valid communication traffic.

In some cases, the policy engine 714 determines, using the one or more security policies, a vehicle speed range at which updates to the functionality of the target device(s), e.g., the one or more sensors, are allowed. If the policy engine 714 determines that a current speed of the vehicle is within the vehicle speed range at which updates to the functionality of the target device(s) are allowed, then the policy engine 714 determines that the communication traffic is valid communication traffic.

In some cases, the policy engine 714 identifies, using the one or more security policies, a digital security certificate that specifies a network interface associated with the vehicle 700 that is allowed for communication for the one or more target devices. If the policy engine 714 determines that the communication traffic is flowing through the identified network interface, then the policy engine 714 determines that the communication traffic is valid communication traffic.

In some cases, the policy engine 714 determines system states of the one or more target devices. The policy engine 714 identifies, using the one or more security policies, at least one communication protocol that is allowed for processing by the one or more destination devices in their respective determined system states. If the policy engine 714 determines that a protocol of the communication traffic corresponds to the at least one communication protocol, then the policy engine 714 determines that the communication traffic is valid communication traffic.

In some cases, the communication traffic includes content traffic for a human-machine interface (HMI) associated with the one or more target devices in the vehicle 700. In such cases, policy engine 714 determines, using one or more security policies for the target device(s), a permitted direction of data flow for content traffic for the HMI. If the policy engine 714 determines that a direction of flow of the communication traffic corresponds to the permitted direction of data flow, then the policy engine 714 determines that the communication traffic is valid communication traffic.

If the security gateway cannot determine that the communication traffic is valid, then the security gateway aborts (808). For example, in some cases, if the policy engine 714 determines that the signature included in the configuration update message does not match the signature the policy engine 714 generated based on the digital certificate of the network update server, the policy engine 714 concludes that the message cannot be authenticated, and is potentially malicious. Accordingly, the policy engine 714 blocks the configuration update message from being forward to the one or more sensors. Additionally, in some cases, the policy engine 714 sends an alert to the AV system of the vehicle 700, or to the operator/administrator of the vehicle 700, or both.

On the other hand, if the security gateway determines that the communication traffic is valid, then the security gateway proceeds to check the communication traffic using at least one device profile for the at least one device (810). For example, in some cases, if the policy engine 714 determines that the signature included in the configuration update message matches the signature the policy engine 714 generated based on the digital certificate of the network update server, the policy engine 714 concludes that the message is authentic. Accordingly, the policy engine 714 releases the configuration update message for being forwarded to the target device(s). The intrusion detection engine 712 then checks the configuration update message using one or more device profiles of the target device(s). The intrusion detection engine 712 accesses from storage device profile(s) corresponding to the target device(s), such as a traffic profile of a target sensor that specifies a typical (e.g., mean and corresponding standard deviations) size of a configuration update message for the sensor.

By checking the communication traffic using at least one device profile for the at least one device, the security gateway determines whether the communication traffic satisfies the device profile characteristics (812). For example, in some cases, the intrusion detection engine 712 checks whether the size of the configuration update message is within an allowable range corresponding to the typical size (e.g., within the standard deviation range of the mean size) of a configuration update message for a sensor included in the one or more target devices, as specified by the traffic profile of the sensor.

In some cases, characteristics of the one or more device profiles include a current consumption characteristic associated with traffic profiles of one or more target devices. In such cases, the intrusion detection engine 712 measures, for each of the one or more target devices, an amount of current consumed by the respective device to process at least a portion of the communication traffic. The intrusion detection engine 712 compares the measured amount of current to an expected amount of current associated with a known traffic profile corresponding to the device. The intrusion detection engine 712 determines that the communication traffic satisfies the current consumption characteristic of the device upon determining that the measured amount of current is within a specified range of the expected amount of current.

In some cases, the one or more device profiles include one or more traffic profiles corresponding to one or more target devices. For each of the target devices, characteristics of a corresponding traffic profile include one or more of a message frequency, a message size, a message error rate, or a response latency. For each target device, the intrusion detection engine 712 computes one or more of a message frequency, a message size, a message error rate, or a response latency associated with the corresponding communication traffic. The intrusion detection engine 712 compares the computed message frequency, the computed message size, the computed message error rate, or the computed response latency respectively to an expected message frequency, an expected message size, an expected message error rate, or an expected response latency associated with the corresponding traffic profile of the device. If the computed message frequency, the computed message size, the computed message error rate, or the computed response latency is determined to be respectively within a specified range of the expected message frequency, the expected message size, the expected message error rate, or the expected response latency, then the intrusion detection engine 712 determines that the communication traffic satisfies the characteristics of the traffic profile of the device.

In some cases, the one or more device profiles include one or more behavior profiles corresponding to one or more target devices, e.g., one or more destination sensors, processors, or memory devices. For each of the target devices, characteristics of a corresponding behavior profile includes one or more of a vehicle speed, a sensor (e.g., LiDAR sensor) spin speed, a processor temperature, or a file input/output. For each target device, the intrusion detection engine 712 computes one or more of a vehicle speed, a LiDAR spin speed, a processor temperature, or a file input/output, as applicable. The intrusion detection engine 712 compares the computed vehicle speed, the computed LiDAR spin speed, the computed processor temperature, or the computed file input/output respectively to an expected vehicle speed, an expected LiDAR spin speed, an expected processor temperature, or an expected file input/output associated with the corresponding behavior profile of the device. If the computed LiDAR spin speed, the computed processor temperature, or the computed file input/output is found to be within a specified range respectively of the expected vehicle speed, the expected LiDAR spin speed, the expected processor temperature, or the expected file input/output, then the intrusion detection engine 712 determines that the communication traffic satisfies the characteristics of the behavior profile of the device.

If the security gateway determines that the communication traffic does not satisfy the at least one device profile of the at least one device, then the security gateway aborts (814). For example, if the intrusion detection engine 712 determines that the size of a configuration update message for a sensor is outside the allowable range corresponding to the typical size of a configuration update message for the sensor (e.g., higher or lower than the standard deviation range from the mean size), the intrusion detection engine 712 concludes that the configuration update message is likely not a valid configuration update message, and is potentially malicious. Accordingly, the intrusion detection engine 712 blocks the configuration update message from being forward to the sensor. Additionally, in some cases, the intrusion detection engine 712 sends an alert to the AV system of the vehicle 700, or to the operator/administrator of the vehicle 700, or both.

In some embodiments, if the security gateway determines that the communication traffic satisfies the at least one device profile of the at least one device, then the security gateway forwards the communication traffic using to the at least one device in the vehicle (816). For example, if the intrusion detection engine 712 determines that the size of the configuration update message for the sensor is within the allowable range corresponding to the typical size of a configuration update message for the sensor (e.g., within the standard deviation range of the mean size), the intrusion detection engine 712 concludes that the configuration update message is a valid configuration update message. Accordingly, the intrusion detection engine 712 releases the configuration update message for being forwarded to the sensor, and the process 800 ends. The AV system of the vehicle 700 subsequently updates the firmware of the sensor based on the configuration update message.

In the above manner, the intrusion detection engine 712 and the policy engine 714 in the security gateway 710 manages security of communication traffic in the vehicle 700. If the check by either intrusion detection engine 712 or the policy engine 714 fail, then the traffic is blocked.

Although the description of process 800 above shows the policy engine 714 performing its operations followed by the intrusion detection engine 712, in some embodiments, the order of operations in the process 800 is reversed, with the intrusion detection engine 712 performing its operations first, followed by the policy engine 714. In some embodiments, the order of operations in the process 800 is such that the intrusion detection engine 712 and the policy engine 714 perform their respective operations in parallel, coordinating with one another as needed.

In the foregoing description, embodiments of the invention have been described with reference to numerous specific details that may vary from implementation to implementation. The description and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further comprising,” in the foregoing description or following claims, what follows this phrase can be an additional step or entity, or a sub-step/sub-entity of a previously-recited step or entity.

1. An apparatus comprising:
a circuit coupled to at least one device in a vehicle and managing communications between the at least one device and entities external to the vehicle, the circuit performing operations comprising:
receiving, from an external entity, communication traffic destined for the at least one device in the vehicle;
determining, using at least one known security policy corresponding to the at least one device whether the communication traffic is valid communication traffic for the at least one device;
determining, using at least one known device profile corresponding to the at least one device, whether the communication traffic satisfies characteristics of the at least one known device profile; and
conditioned on determining that (i) the communication traffic is valid communication traffic for the at least one device, and (ii) the communication traffic satisfies the characteristics of the at least one known device profile, forwarding the communication traffic to the at least one device.

2. The apparatus of claim 1, wherein determining whether the communication traffic is valid communication traffic for the at least one device using the at least one known security policy corresponding to the at least one device comprises:
obtaining, from information included in the communication traffic, an identifier of the at least one device;
using the identifier of the at least one device, retrieving, from storage coupled to the apparatus, the at least one known security policy corresponding to the at least one device; and
determining whether the communication traffic satisfies the at least one known security policy.

3. The apparatus of claim 1, wherein the communication traffic comprises traffic to update functionality of the at least one device, and wherein determining whether the communication traffic is valid communication traffic for the at least one device using the at least one known security policy corresponding to the at least one device comprises:
determining, using the at least one known security policy, a security certificate of a trusted network entity authorized to update the functionality of the at least one device; and
determining that the communication traffic is valid communication traffic upon successfully authenticating the communication traffic based at least on the security certificate of the trusted network entity.

4. The apparatus of claim 1, wherein the communication traffic comprises traffic to update functionality of the at least one device, and wherein determining whether the communication traffic is valid communication traffic for the at least one device using the at least one known security policy corresponding to the at least one device comprises:
determining, using the at least one known security policy, a vehicle speed range at which updates to the functionality of the at least one device are allowed; and
determining that the communication traffic is valid communication traffic upon determining that a current speed of the vehicle is within the vehicle speed range at which updates to the functionality of the at least one device are allowed.

5. The apparatus of claim 1, wherein the communication traffic comprises content traffic for a human-machine interface (HMI) associated with the at least one device, and wherein determining whether the communication traffic is valid communication traffic for the at least one device using the at least one known security policy corresponding to the at least one device comprises:
determining, using the at least one known security policy, a permitted direction of data flow for content traffic for the HMI; and
determining that the communication traffic is valid communication traffic upon determining that a direction of flow of the communication traffic corresponds to the permitted direction of data flow.

6. The apparatus of claim 1, wherein determining whether the communication traffic is valid communication traffic for the at least one device using the at least one known security policy corresponding to the at least one device comprises:
identifying, using the at least one known security policy, a digital security certificate that specifies a network interface associated with the vehicle that is allowed for communication for the at least one device; and
determining that the communication traffic is valid communication traffic upon determining that the communication traffic is flowing through the identified network interface.

7. The apparatus of claim 1, wherein determining whether the communication traffic is valid communication traffic for the at least one device using the at least one known security policy corresponding to the at least one device comprises:
determining a system state of the at least one device;
identifying, using the at least one known security policy, at least one communication protocol that is allowed for processing by the at least one device in the determined system state; and
determining that the communication traffic is valid communication traffic upon determining that a protocol of the communication traffic corresponds to the at least one communication protocol.

8. The apparatus of claim 1, wherein a characteristic of the at least one known device profile comprises a current consumption characteristic, and wherein determining that the communication traffic satisfies characteristics of the at least one known device profile corresponding to the at least one device comprises:
measuring an amount of current consumed by the at least one device to process at least a portion of the communication traffic;
comparing the measured amount of current to an expected amount of current associated with a known traffic profile corresponding to the at least one device; and
determining that the communication traffic satisfies the current consumption characteristic upon determining that the measured amount of current is within a specified range of the expected amount of current.

9. The apparatus of claim 1, wherein the at least one known device profile comprises a traffic profile corresponding to the device, a characteristic of the traffic profile comprising at least one of a message frequency, a message size, a message error rate, or a response latency, and
wherein determining that the communication traffic satisfies characteristics of the at least one known device profile corresponding to the at least one device comprises:
computing at least one of message frequency, a message size, a message error rate, or a response latency associated with the communication traffic;
comparing the computed message frequency, the computed message size, the computed message error rate, or the computed response latency respectively to an expected message frequency, an expected message size, an expected message error rate, or an expected response latency associated with a known traffic profile corresponding to the at least one device; and
determining that the communication traffic satisfies the characteristics of the at least one known device profile upon determining that the computed message frequency, the computed message size, the computed message error rate, or the computed response latency is respectively within a specified range of the expected message frequency, the expected message size, the expected message error rate, or the expected response latency.

10. The apparatus of claim 1, wherein at least one known device profile comprises a behavior profile corresponding to the device, a characteristic of the behavior profile comprising at least one of a vehicle speed, a LiDAR spin speed, a processor temperature, or a file input/output, and
wherein determining that the communication traffic satisfies characteristics of the at least one known device profile corresponding to the at least one device comprises:
computing at least one of a vehicle speed, a LiDAR spin speed, a processor temperature, or a file input/output;
comparing the computed vehicle speed, the computed LiDAR spin speed, the computed processor temperature, or the computed file input/output respectively to an expected vehicle speed, an expected LiDAR spin speed, an expected processor temperature, or an expected file input/output associated with a known behavior profile corresponding to the at least one device; and
determining that the communication traffic satisfies the characteristics of the at least one known device profile upon determining that the computed vehicle speed, the computed LiDAR spin speed, the computed processor temperature, or the computed file input/output is respectively within a specified range of the expected vehicle speed, the expected LiDAR spin speed, the expected processor temperature, or the expected file input/output.

11. A method performed by a security gateway in a vehicle, the method comprising:
receiving, from an external entity communication traffic destined for at least one device in the vehicle that is communicably coupled to the security gateway, wherein the security gateway manages communications between the at least one device and entities external to the vehicle
determining, using at least one known security policy corresponding to the at least one device whether the communication traffic is valid communication traffic for the at least one device;
determining, using at least one known device profile corresponding to the at least one device, whether the communication traffic satisfies characteristics of the at least one known device profile; and
conditioned on determining that (i) the communication traffic is valid communication traffic for the at least one device, and (ii) the communication traffic satisfies the characteristics of the at least one known device profile, forwarding the communication traffic to the at least one device.

12. The method of claim 11, wherein determining whether the communication traffic is valid communication traffic for the at least one device using the at least one known security policy corresponding to the at least one device comprises:
obtaining, from information included in the communication traffic, an identifier of the at least one device;
using the identifier of the at least one device, retrieving, from storage coupled to the security gateway, the at least one known security policy corresponding to the at least one device; and
determining whether the communication traffic satisfies the at least one known security policy.

13. The method of claim 11, wherein the communication traffic comprises traffic to update functionality of the at least one device, and wherein determining whether the communication traffic is valid communication traffic for the at least one device using the at least one known security policy corresponding to the at least one device comprises:
determining, using the at least one known security policy, a security certificate of a trusted network entity authorized to update the functionality of the at least one device; and
determining that the communication traffic is valid communication traffic upon successfully authenticating the communication traffic based at least on the security certificate of the trusted network entity.

14. The method of claim 11, wherein the communication traffic comprises traffic to update functionality of the at least one device, and wherein determining whether the communication traffic is valid communication traffic for the at least one device using the at least one known security policy corresponding to the at least one device comprises:
determining, using the at least one known security policy, a vehicle speed range at which updates to the functionality of the at least one device are allowed; and
determining that the communication traffic is valid communication traffic upon determining that a current speed of the vehicle is within the vehicle speed range at which updates to the functionality of the at least one device are allowed.

15. The method of claim 11, wherein the communication traffic comprises content traffic for a human-machine interface (HMI) associated with the at least one device, and wherein determining whether the communication traffic is valid communication traffic for the at least one device using the at least one known security policy corresponding to the at least one device comprises:
determining, using the at least one known security policy, a permitted direction of data flow for content traffic for the HMI; and
determining that the communication traffic is valid communication traffic upon determining that a direction of flow of the communication traffic corresponds to the permitted direction of data flow.

16. The method of claim 11, wherein determining whether the communication traffic is valid communication traffic for the at least one device using the at least one known security policy corresponding to the at least one device comprises:
identifying, using the at least one known security policy, a digital security certificate that specifies a network interface associated with the vehicle that is allowed for communication for the at least one device; and
determining that the communication traffic is valid communication traffic upon determining that the communication traffic is flowing through the identified network interface.

17. The method of claim 11, wherein determining whether the communication traffic is valid communication traffic for the at least one device using the at least one known security policy corresponding to the at least one device comprises:
determining a system state of the at least one device;
identifying, using the at least one known security policy, at least one communication protocol that is allowed for processing by the at least one device in the determined system state; and
determining that the communication traffic is valid communication traffic upon determining that a protocol of the communication traffic corresponds to the at least one communication protocol.

18. The method of claim 11, wherein a characteristic of the at least one known device profile comprises a current consumption characteristic, and wherein determining that the communication traffic satisfies characteristics of the at least one known device profile corresponding to the at least one device comprises:
measuring an amount of current consumed by the at least one device to process at least a portion of the communication traffic;
comparing the measured amount of current to an expected amount of current associated with a known traffic profile corresponding to the at least one device; and
determining that the communication traffic satisfies the current consumption characteristic upon determining that the measured amount of current is within a specified range of the expected amount of current.

19. The method of claim 11, wherein the at least one known device profile comprises a traffic profile corresponding to the device, a characteristic of the traffic profile comprising at least one of a message frequency, a message size, a message error rate, or a response latency, and
wherein determining that the communication traffic satisfies characteristics of the at least one known device profile corresponding to the at least one device comprises:
computing at least one of message frequency, a message size, a message error rate, or a response latency associated with the communication traffic;
comparing the computed message frequency, the computed message size, the computed message error rate, or the computed response latency respectively to an expected message frequency, an expected message size, an expected message error rate, or an expected response latency associated with a known traffic profile corresponding to the at least one device; and
determining that the communication traffic satisfies the characteristics of the at least one known device profile upon determining that the computed message frequency, the computed message size, the computed message error rate, or the computed response latency is respectively within a specified range of the expected message frequency, the expected message size, the expected message error rate, or the expected response latency.

20. The method of claim 11, wherein at least one known device profile comprises a behavior profile corresponding to the device, a characteristic of the behavior profile comprising at least one of a vehicle speed, a LiDAR spin speed, a processor temperature, or a file input/output, and
wherein determining that the communication traffic satisfies characteristics of the at least one known device profile corresponding to the at least one device comprises:
computing at least one of a vehicle speed, a LiDAR spin speed, a processor temperature, or a file input/output;
comparing the computed vehicle speed, the computed LiDAR spin speed, the computed processor temperature, or the computed file input/output respectively to an expected vehicle speed, an expected LiDAR spin speed, an expected processor temperature, or an expected file input/output associated with a known behavior profile corresponding to the at least one device; and
determining that the communication traffic satisfies the characteristics of the at least one known device profile upon determining that the computed vehicle speed, the computed LiDAR spin speed, the computed processor temperature, or the computed file input/output is respectively within a specified range of the expected vehicle speed, the expected LiDAR spin speed, the expected processor temperature, or the expected file input/output.

21. A vehicle comprising:
a security gateway comprising circuitry coupled to at least one device in a vehicle and managing communications between the at least one device and entities external to the vehicle the circuitry performing operations comprising:
receiving, from an external entity, communication traffic destined for the at least one device in the vehicle;
determining, using at least one known security policy corresponding to the at least one device whether the communication traffic is valid communication traffic for the at least one device;
determining, using at least one known device profile corresponding to the at least one device, whether the communication traffic satisfies characteristics of the at least one known device profile; and
conditioned on determining that (i) the communication traffic is valid communication traffic for the at least one device, and (ii) the communication traffic satisfies the characteristics of the at least one known device profile, forwarding the communication traffic to the at least one device.
